(19) United States
(12) Patent Application Publication
(10) Pub. No.: US 2019/0156024 A1
(43) Pub. Date: May 23, 2019

(54) METHOD AND APPARATUS FOR AUTOMATICALLY CLASSIFYING MALIGNANT CODE ON BASIS OF MALIGNANT BEHAVIOR INFORMATION

(71) Applicant: SOMANSA CO., LTD., Seoul (KR)

(72) Inventors: Sang Wook KIM, Seoul (KR); Tae Wan KIM, Seoul (KR); Il Hoon CHOI, Seoul (KR)

(73) Assignee: SOMANSA CO., LTD.

(21) Appl. No.: 15/823,929

(22) Filed: Nov. 28, 2017

(30) Foreign Application Priority Data
Nov. 20, 2017 (KR) 10-2017-0154438

(51) Int. Cl. G06F 21/54

(52) U.S. Cl. CPC G06F 21/54; G06F 2221/033

(57) ABSTRACT

Disclosed is a method of automatically classifying a malignant code on the basis of malignant behavior information. The method includes configuring a process table comprising an application programming interface (API) mapping table and a behavior mapping table corresponding to each of processes according to a start of execution of the processes, detecting malignant behavior of an executed process which is currently being executed, by using a malignant behavior metatable which stores malignant behavior information related to each of the processes, and classifying a malignant code related to the detected malignant behavior by using a malignant code classification metatable which stores pieces of information on representative malignant behaviors which configure malignant codes.

### CROSS-REFERENCE TO RELATED APPLICATION

This application claims priority to and the benefit of Korean Patent Application No. 10-2017-0154438, filed on Nov. 20, 2017, the disclosure of which is incorporated herein by reference in its entirety.

### FIELD

The present invention relates to a technology for automatically classifying a malignant code type by detecting a corresponding malignant behavior in a process life cycle, generated by a general user environment (end point).

### BACKGROUND

Cyber attacks through the Internet have become intelligent and advanced. It is no exaggeration to say that signature-based antivirus products which have been used for detecting malignant codes are currently rendered useless. Malignant code developers including hackers periodically manufacture and distribute malignant codes with new signature by reusing sources of malignant codes to incapacitate signature-based security products.

Accordingly, recently, security products generally employ a behavior-based detection method of detecting a malignant code by analyzing behavior of the malignant code in a virtual environment. However, due to restrictions of a virtual environment used for analyzing a malignant code, whether a code is malignant is determined by monitoring for a short time of several minutes. Making bad use of this, malignant codes may be designed to do malignant codes' intrinsic behavior after a certain time passes to bypass a security product. Also, as functions of malignant codes have diversified, it is necessary to respond according to a type of malignant code.

Accordingly, it is necessary to detect behavior of a malignant code with no signature in a process life cycle at a user environment (end point) and to classify a malignant code type by analyzing malignant behavior information.

Also, recently, although a variety of methods and systems for detecting a malignant code analyzing behavior related to malignant code have been studied, since it is impossible to analyze for a long time due to restrictions in virtual environments for analyzing malignant codes such that recent malignant codes bypass the analysis using a method of performing an intrinsic malignant behavior after a certain time passes, it is necessary to respond thereto.

### SUMMARY

It is an aspect of the present invention to provide a method and an apparatus for automatically classifying a malignant code on the basis of malignant behavior information, in which malignant behavior is detected by managing a life cycle of a process and analyzing an application programming interface (API) call sequence executed after executing the process and a type of a malignant code is automatically classified.

According to one aspect of the present invention, a method of automatically classifying a malignant code on the basis of malignant behavior information includes configuring a process table including an API mapping table and a behavior mapping table corresponding to each of processes according to a start of execution of the processes, detecting malignant behavior of an executed process which is currently being executed, by using a malignant behavior metatable which stores malignant behavior information related to each of the processes, and classifying a malignant code related to the detected malignant behavior by using a malignant code classification metatable which stores pieces of information on representative malignant behaviors which configure malignant codes.

The detecting of the malignant behavior may include extracting the API mapping table corresponding to the executed process from the process table, extracting a malignant behavior sequence which includes an API call of the executed process by using the malignant behavior metatable, mapping an index of an API call sequence corresponding to the API call to an API mapping bit array of the malignant behavior sequence in the API mapping table, determining whether the whole API mapping bit array of the malignant behavior sequence is mapped with the index of the API call sequence, and registering, when the whole API mapping bit array is mapped with the index of the API call sequence, behavior of the executed process corresponding to the malignant behavior sequence to be malignant behavior.

The malignant behavior metatable may include a malignant behavior sequence, malignant behavior information, and an API call sequence table for detecting behaviors of previously analyzed malignant codes.

The API mapping table and the malignant behavior metatable may include the same malignant behavior sequence.

The number of the API call sequences may be identical to the number of bits of the API mapping bit array.

The classifying of the malignant code may include extracting a behavior mapping table corresponding to the executed process from the process table, extracting a malignant code sequence which includes the detected malignant behavior by using the malignant code classification metatable, mapping an index of the malignant behavior sequence corresponding to the detected malignant behavior to a behavior mapping bit array of the malignant code sequence in the behavior mapping table, determining whether the whole behavior mapping bit array of the malignant code sequence is mapped with the index of the malignant behavior sequence, and registering, when the whole behavior mapping bit array is mapped with the index of the malignant behavior sequence, behavior of the executed process corresponding to the malignant code sequence to be the malignant code.

The malignant code classification metatable may include a malignant code sequence, malignant behavior information, and a malignant behavior sequence table for detecting representative behaviors of previously analyzed malignant codes.

The behavior mapping table and the malignant code classification metatable may include the same malignant code sequence.

The number of the malignant behavior sequences may be identical to the number of bits of the behavior mapping bit array.

The method may further include determining whether an operation of the executed process is completed and deleting a list of the executed process from the process table when the operation of the executed process is completed.

The determining of whether the operation of the executed process is completed may include determining whether the operation of the executed process is completed by comparing a process list of the process table with a process list of processes which is being actually executed.

According to another aspect of the present invention, an apparatus for automatically classifying a malignant code on the basis of malignant behavior information includes a controller which configures a process table including an API mapping table and a behavior mapping table corresponding to each of processes according to a start of the processes, a first processor which detects malignant behavior of an executed process which is currently being executed, by using a malignant behavior metatable which stores malignant behavior information related to each of the processes, a second processor which classifies a malignant code related to the detected malignant behavior by using a malignant code classification metatable which stores pieces of information on representative malignant behaviors which configure malignant codes, and a database which stores at least one of information related the API mapping table, information related the behavior mapping table, information related the process table, information related the malignant behavior metatable, and information related to the malignant code classification metatable.

The first processor may extract the API mapping table corresponding to the executed process from the process table, may extract a malignant behavior sequence which includes an API call of the executed process by using the malignant behavior metatable, may map an index of an API call sequence corresponding to the API call to an API mapping bit array of the malignant behavior sequence in the API mapping table, may determine whether the whole API mapping bit array of the malignant behavior sequence is mapped with the index of the API call sequence, and may register, when the whole API mapping bit array is mapped with the index of the API call sequence, behavior of the executed process corresponding to the malignant behavior sequence to be malignant behavior.

The second processor may extract a behavior mapping table corresponding to the executed process from the process table, may extract a malignant code sequence which includes the detected malignant behavior by using the malignant code classification metatable, may map an index of the malignant behavior sequence corresponding to the detected malignant behavior to a behavior mapping bit array of the malignant code sequence in the behavior mapping table, may determine whether the whole behavior mapping bit array of the malignant code sequence is mapped with the index of the malignant behavior sequence, and may register, when the whole behavior mapping bit array is mapped with the index of the malignant behavior sequence, behavior of the executed process corresponding to the malignant code sequence to be the malignant code.

The controller may determine whether an operation of the executed process is completed and may delete a list of the executed process from the process table when the operation of the executed process is completed.

The controller may determine an operation of the executed process is completed by comparing a process list of the process table with a process list of processes which is being actually executed.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of an automatic malignant code classification apparatus based on malignant behavior information according to one embodiment of the present invention;

FIG. 2 is a reference view illustrating a process table according one embodiment of the present invention;

FIG. 3 is a reference view illustrating a malignant behavior metatable according one embodiment of the present invention;

FIG. 4 is a reference view illustrating one example of an application programming interface (API) mapping table of an executed process;

FIG. 5 is a reference view illustrating a malignant code classification metatable according one embodiment of the present invention;

FIG. 6 is a reference view illustrating one example of a behavior mapping table of an executed process;

FIG. 7 is a reference view illustrating one example of an operation of a controller to determine whether a process is completed;

FIG. 8 is a flowchart illustration a method for automatically classifying a malignant code on the basis of malignant behavior information according to one embodiment of the present invention;

FIG. 9 is a flowchart illustrating one example of a process of detecting malignant behavior of the executed process shown in FIG. 8; and

FIG. 10 is a flowchart illustrating one example of a process of classifying a malignant code related to the detected malignant behavior shown in FIG. 8.

### DETAILED DESCRIPTION

Hereinafter, exemplary embodiments of the present disclosure will be described in detail with reference to the attached drawings.

The embodiments of the present invention are provided to more completely explain the present invention to one of ordinary skill in the art. The following embodiments may be modified into various different forms, and the scope of the present invention is not limited thereto. The embodiments are provided to make the disclosure more substantial and complete and to completely convey the concept to those skilled in the art.

The terms are used herein to explain particular embodiments and are not intended to limit the present invention. As used herein, singular forms, unless contextually defined otherwise, may include plural forms. Also, as used herein, the term “and/or” includes any and all combinations or one of a plurality of associated listed items.

Hereinafter, the embodiments of the present invention will be described with reference to the drawings which schematically illustrate the embodiments.

It is necessary to actively respond an intelligent and advanced cyber attack by monitoring an application program interface (API) calls of a process executed in a user environment, detecting malignant behavior by analyzing collected API call sequence information, and responding for each malignant code type by using malignant code automatic classification information classified using the detected malignant behavior information.

The present invention relates to a method and an apparatus for classifying a malignant code type through detecting malignant behavior through API call sequence analysis executed in a process life cycle generated in a general user environment (end point) and analyzing detected malignant behavior information.

Process life cycle management, malignant behavior detection, and malignant code type classification in a user environment will be described. An agent installed in a user environment monitors execution and termination of a process and configures a process table for managing a process life cycle. When a process is executed, a malignant behavior mapping table for storing information for detecting malignant behavior including process information is generated and added in the process table. When the process is terminated, corresponding process information is deleted from the process table.

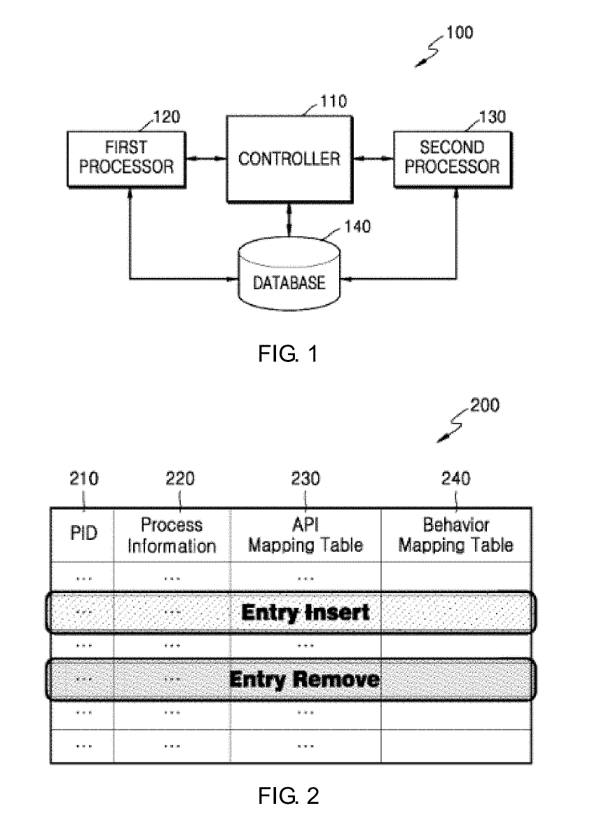

FIG. 1 is a block diagram of an automatic malignant code classification apparatus 100 based on malignant behavior information according to one embodiment of the present invention.

Referring to FIG. 1, the automatic malignant code classification apparatus 100 includes a controller 110, a first processor 120, a second processor 130, and a database 140.

The controller 110 monitors execution and termination of processes. For this, the controller 110 configures a process table for managing process life cycles.

FIG. 2 is a reference view illustrating a process table 200 according one embodiment of the present invention.

Referring to FIG. 2, the process table 200 may include a process identification (PID) 210, process information 220, an API mapping table 230, and behavior mapping table 240.

The PID 210 may include identification information on a process being executed. Also, the process information 220 may include general registration information related execution of process. Also, the API mapping table 230 refers to a table for mapping with an API call sequence corresponding to malignant behavior, which will be described below. Also, the behavior mapping table 240 refers to a table for mapping with a malignant code sequence corresponding to malignant behavior.

The controller 110 may configure a process table including an API mapping table and a behavior mapping table corresponding to each of processes according to a start of executing the processes. As shown in FIG. 2, when execution of a new process is started, the controller 110 may configure a process list including the PID 210, the process information 220, the API mapping table 230, and the behavior mapping table 240 related to the processor whose execution is started, in the process table (Entry Insert).

The first processor 120 detects malignant behavior of an executed process which is being currently executed, using a malignant behavior metatable which stores pieces of malignant behavior information on processors.

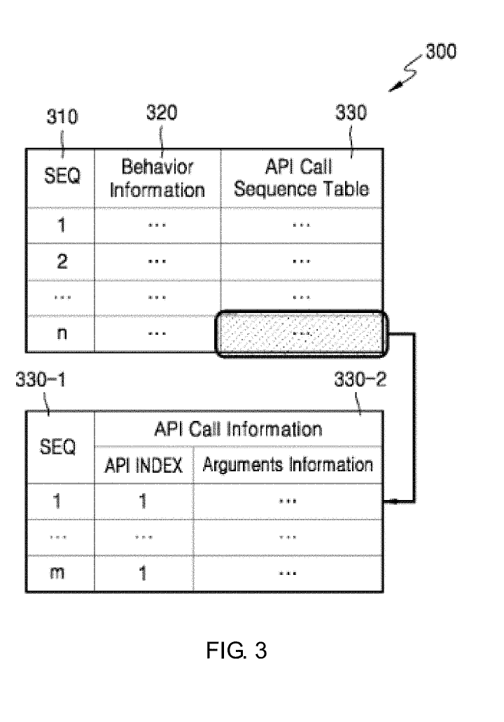

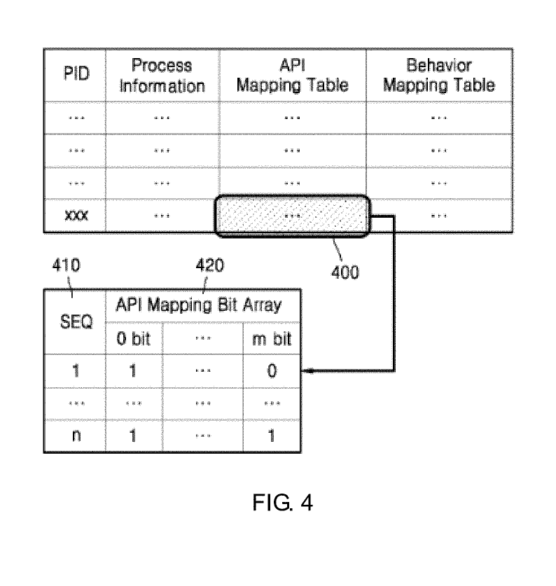

FIG. 3 is a reference view illustrating a malignant behavior metatable 300 according one embodiment of the present invention, and FIG. 4 is a reference view illustrating one example of an API mapping table of an executed process (for example, xxx).

Referring to FIG. 3, the malignant behavior metatable 300 includes information for detecting behaviors of malignant codes previously analyzed. The malignant behavior metatable 300 may include a malignant behavior sequence 310, malignant behavior information 320, and an API call sequence table 330. The malignant behavior sequence 310 may include n number of sequences corresponding to malignant behavior identification information. The malignant behavior information 320 includes operation characteristic information of malignant behavior. The API call sequence table 330 includes API call-related information of each malignant behavior. In detail, the API call sequence table 330 may include an API call sequence 330-1 and API call information 330-2. The API call sequence 330-1 may include m number of sequences corresponding to API call identification information. The API call information 330-2 may include API index information for mapping with the API mapping table 400. Meanwhile, even when the same API is executed, since behavior is determined according to an execution factor, factor information at the execution of API is included.

Referring to FIG. 4, the API mapping table 400 may include a malignant behavior sequence 410 and an API mapping bit array 420. The malignant behavior sequence 410 may include n number of sequences corresponding to malignant behavior identification information and the number n is identical to the n number of malignant behavior sequences 310 retained in the malignant behavior metatable 300. The API mapping bit array 420 includes a bit array to be mapped with the index of the API call sequence 330-1 of the malignant behavior metatable 300 and may include m number of API mapping bits, which is identical to the m number of API call sequences 330-1 retained in the malignant behavior metatable 300.

The first processor 120 extracts an API mapping table corresponding to a process being currently executed. For example, the first processor 120 extracts the API mapping table 400 corresponding to the executed process (for example, xxx) from the process table 200 configured by the controller 110. The extracted API mapping table 400 only includes n number of malignant behavior sequences 410, and the API mapping bit array 420 still remains in a state before being mapped with the index of the API call sequence 330-1.

The first processor 120 extracts a malignant behavior sequence including an API call of an executed process, using a malignant behavior metatable. For example, the first processor 120 may extract at least one malignant behavior sequence 310 including an API call of the process being currently executed, from the malignant behavior metatable 300 as shown in FIG. 3.

The first processor 120 maps an index of an API call sequence corresponding to an API call of a process being currently executed, to an API mapping bit array of a malignant behavior sequence in an API mapping table. For example, the first processor 120 may extract an index API INDEX of the API call information 330-2 corresponding to the API call sequence 330-1 with reference to the API call sequence table 330 of the malignant behavior metatable 300 as shown in FIG. 3. After that, the first processor 120 maps the index API INDEX of the API call information 330-2 to the API mapping bit array 420 corresponding to the malignant behavior sequence 410 which includes an API call in the API mapping table 400 as shown in FIG. 4. Here, the index API INDEX of the API call information 330-2 may be represented by a value of “0” or “1.”

The first processor 120 determines whether the whole API mapping bit array of the malignant behavior sequence are mapped with the index of the API call sequence and registers behavior of the executed process corresponding to the malignant behavior sequence to be malignant behavior when the whole API mapping bit array is mapped with the index of the API call sequence. For example, the first processor 120 determines whether the whole API mapping bit array 420 shown in FIG. 4 is mapped with a value of “1” corresponding to the index API INDEX of the API call information 330-2. When the whole API mapping bit array 420 is mapped with the value of “1” corresponding to the index API INDEX of the API call information 330-2, the first processor 120 may detect and register the behavior of the executed process corresponding to the malignant behavior sequence 410 or the malignant behavior sequence 330-1 to be malignant behavior.

The second processor 130 classifies a malignant code related to malignant behavior detected by the first processor 120, using a malignant code classification metatable which stores pieces of information on representative malignant behaviors which configure malignant codes.

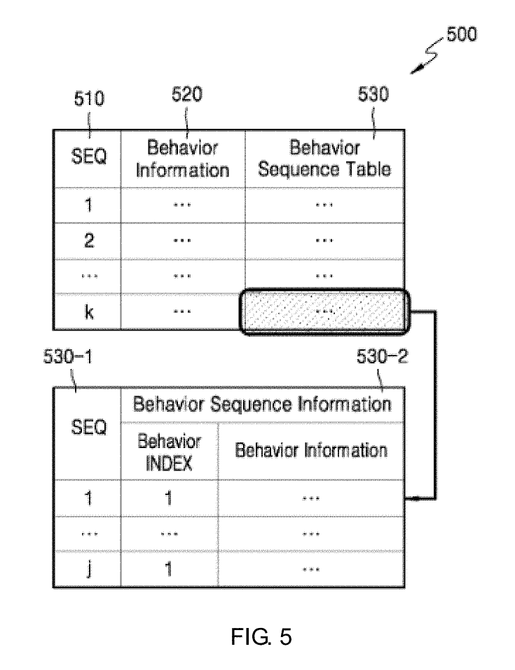

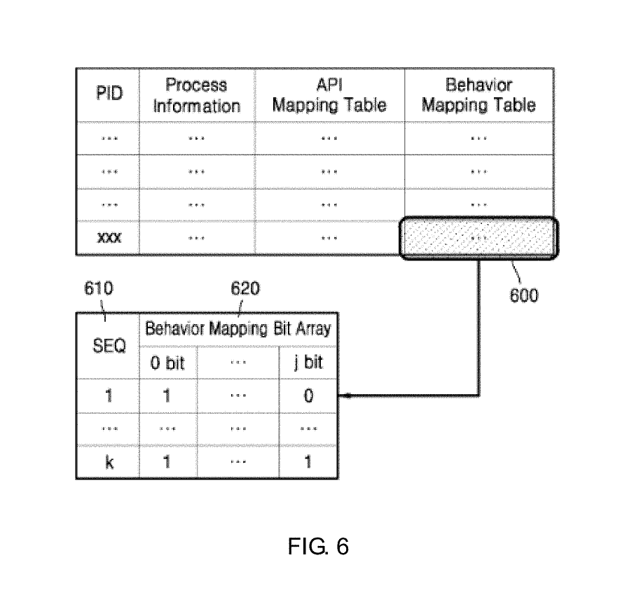

FIG. 5 is a reference view illustrating a malignant code classification metatable 500 according one embodiment of the present invention, and FIG. 6 is a reference view illustrating one example of a behavior mapping table 600 of an executed process (for example, xxx).

Referring to FIG. 5, the malignant code classification metatable 500 includes information for detecting representative behaviors of malignant codes previously analyzed. The malignant code classification metatable 500 may include a malignant code sequence 510, malignant behavior information 520, and a malignant behavior sequence table 530. The malignant code sequence 510 may include k number of sequences corresponding to malignant code identification information. The malignant behavior information 520 includes operation characteristic information of malignant behavior. The malignant behavior sequence table 530 includes sequence-related information of each malignant behavior. In detail, the malignant behavior sequence table 530 may include a malignant behavior sequence 530-1 and a malignant behavior index information 530-2 according to malignant code classification. The malignant behavior sequence 530-1 may include j number of sequences corresponding to malignant behavior identification information. The malignant behavior index information 530-2 may include index information for mapping with a behavior mapping table.

Referring to FIG. 6, the behavior mapping table 600 may include a malignant code sequence 610 and a behavior mapping bit array 620. The malignant code sequence 610 may include k number of sequences corresponding to malignant code identification information and the number k is identical to the k number of malignant code sequences 510 retained in the malignant code classification metatable 500. The behavior mapping bit array 620 includes a bit array to be mapped with the index of the malignant behavior sequence 530-1 of the malignant code classification metatable 500 and may include the number j number of behavior mapping bits, which is identical to the j number of malignant behavior sequences 530-1 retained in the malignant code classification metatable 500.

The second processor 130 extracts a behavior mapping table corresponding to a process being currently executed. For example, the second processor 130 extracts the behavior mapping table 600 corresponding to an executed process (for example, xxx) from the process table 200 configured by the controller 110. The extracted behavior mapping table 600 only includes k number of malignant code sequences 610, and the behavior mapping bit array 620 still remains in a state before being mapped with the index of the malignant behavior sequence 530-1.

The second processor 130 extracts a malignant code sequence including malignant behavior detected using a malignant code classification metatable. For example, the second processor 130 may extract at least one malignant code sequence 510 including malignant behavior being currently detected, from the malignant code classification metatable 500 as shown in FIG. 5.

The second processor 130 maps an index of a malignant behavior sequence corresponding to the detected malignant behavior to a behavior mapping bit array of a malignant code sequence of a behavior mapping table. For example, the second processor 130 may extract an index BEHAVIOR INDEX of the malignant behavior index information 530-2 corresponding to the malignant behavior sequence 530-1 with reference to the malignant behavior sequence table 530 of the malignant code classification metatable 500 as shown in FIG. 5. After that, the second processor 130 maps the index BEHAVIOR INDEX of the malignant behavior index information 530-2 to the behavior mapping bit array 620 corresponding to the malignant code sequence 610 which includes malignant behavior in the behavior mapping table 600 as shown in FIG. 6. Here, the index BEHAVIOR INDEX of the malignant behavior index information 530-2 may be represented by a value of “0” or “1.”

The second processor 130 determines whether the whole behavior mapping bit array of the malignant code sequence is mapped to the index of the malignant behavior sequence and registers behavior of the executed process corresponding to the malignant code sequence when the whole behavior mapping bit array is mapped to the index of the malignant behavior sequence. For example, the second processor 130 determines whether the whole behavior mapping bit array 620 shown in FIG. 6 is mapped with a value of “1” corresponding to the index BEHAVIOR INDEX of the malignant behavior index information 530-2. When the whole behavior mapping bit array 620 is mapped with the value of “1” corresponding to the index BEHAVIOR INDEX of the malignant behavior index information 530-2, the second processor 130 may classify and register the behavior of the executed process corresponding to the malignant code sequence 610 or the malignant code sequence 530-1 to be a malignant code.

Meanwhile, the controller 110 determines whether an operation of the executed process is completed and deletes a list of the executed process from the process table when the operation of the executed process is completed.

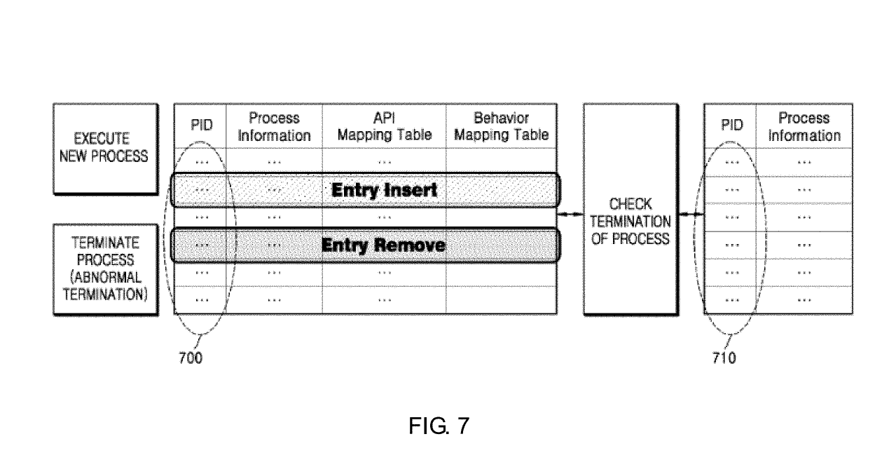

FIG. 7 is a reference view illustrating one example of an operation of the controller to determine whether a process is completed.

Referring to FIG. 7, the controller 110 determines whether an operation of an executed process is completed, by comparing a process list 700 of the process table with a process list 710 of processes being actually executed. The controller 110 may perform process termination by identifying a process which is not currently being executed among processes of the process table through looking up processes to identify process termination caused by forced termination such as a crash and the like. That is, a process which does not exist in the process list 710 being actually executed in the process list 700 of the process table is determined to be terminated in execution thereof and is deleted from the process table (Entry Remove).

The database 140 stores at least one of information related to the API mapping table, information related to the behavior mapping table, information related to the process table, information related to the malignant behavior metatable, and information related to the malignant code classification metatable, which are above-described. The database 140 stores information on a program for monitoring a process, information on a program for detecting malignant behavior, information on a program for classifying malignant codes, and the like. Accordingly, the database 140 provides pieces of information necessary for the operations of monitoring a process, detecting malignant behavior, and classifying malignant codes to the controller 110, the first processor 120, or the second processor 130 in response to access to the controller 110, the first processor 120, or the second processor 130.

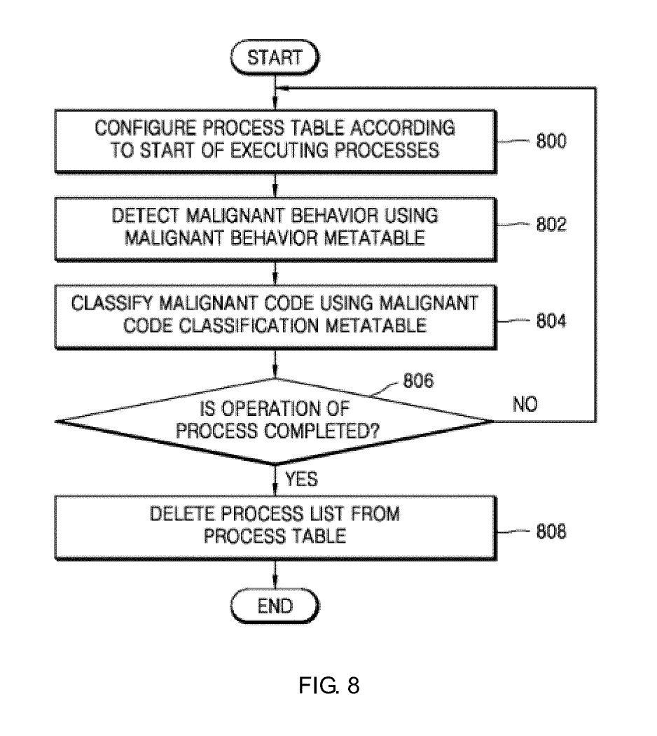

FIG. 8 is a flowchart illustration a method for automatically classifying a malignant code on the basis of malignant behavior information according to one embodiment of the present invention.

An automatic malignant code classification apparatus configures a process table including an API mapping table and a behavior mapping table corresponding to each of process according to a start of executing the processes (800). The process table may include a PID, process information, the API mapping table, and the behavior mapping table. As shown in FIG. 2, when execution of a new process is started, the automatic malignant code classification apparatus may configure a process list including the PID 210, the process information 220, the API mapping table 230, and the behavior mapping table 240 related to the processor whose execution is started, in the process table (Entry Insert).

After operation 800, the automatic malignant code classification apparatus detects malignant behavior of an executed process being currently executed, using a malignant behavior metatable which stores malignant behavior information related to each of the processes (802).

As shown in FIG. 3, the malignant behavior metatable 300 may include the malignant behavior sequence 310, the malignant behavior information 320, and the API call sequence table 330. The malignant behavior sequence 310 may include n number of sequences corresponding to malignant behavior identification information. Also, the API call sequence table 330 may include the API call sequence 330-1 and the API call information 330-2. The API call sequence 330-1 may include m number of sequences corresponding to API call identification information. The API call information 330-2 may include API index information for mapping with the API mapping table.

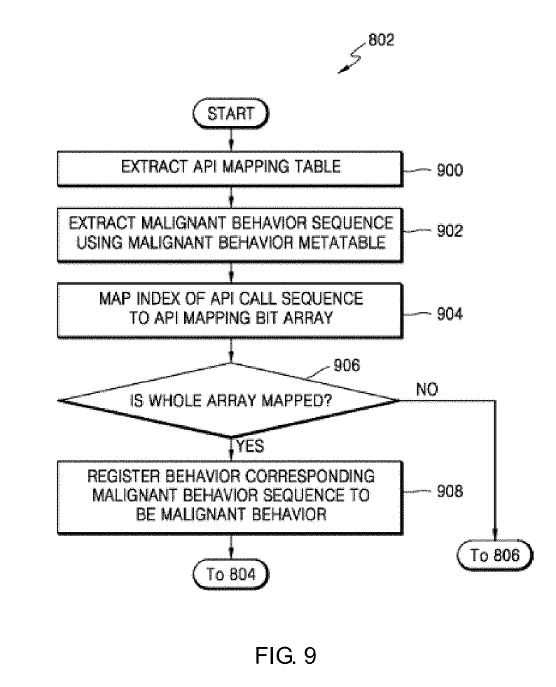

FIG. 9 is a flowchart illustrating one example of a process of detecting malignant behavior of the executed process shown in FIG. 8.

The automatic malignant code classification apparatus extracts an API mapping table corresponding to the executed process from the process table (900). As shown in FIG. 4, the API mapping table 400 may include the malignant behavior sequence 410 and the API mapping bit array 420. The malignant behavior sequence 410 may include n number of sequences corresponding to malignant behavior identification information and the number n is identical to the n number of malignant behavior sequences 310 retained in the malignant behavior metatable 300. The API mapping bit array 420 includes a bit array to be mapped with the index of the API call sequence 330-1 of the malignant behavior metatable 300 and may include m number of API mapping bits, which is identical to the m number of API call sequences 330-1 retained in the malignant behavior metatable 300. For example, the automatic malignant code classification apparatus extracts the API mapping table 400 corresponding to an executed process (for example, xxx) from the process table 200. The extracted API mapping table 400 includes n number of malignant behavior sequences 410.

After operation 900, the automatic malignant code classification apparatus extracts a malignant behavior sequence including an API call of the executed process, using the malignant behavior metatable (902). For example, the automatic malignant code classification apparatus may extract at least one malignant behavior sequence 310 including an API call of the process being currently executed, from the malignant behavior metatable 300 as shown in FIG. 3.

After operation 902, the automatic malignant code classification apparatus maps an index of an API call sequence corresponding to the API call to the API mapping bit array of the malignant behavior sequence in the API mapping table (904). For example, the automatic malignant code classification apparatus may extract the index API INDEX of the API call information 330-2 corresponding to the API call sequence 330-1 with reference to the API call sequence table 330 of the malignant behavior metatable 300 as shown in FIG. 3. Afterward, the automatic malignant code classification apparatus maps the index API INDEX of the API call information 330-2 to the API mapping bit array 420 corresponding to the malignant behavior sequence 410 which includes the API call in the API mapping table 400 as shown in FIG. 4. Here, the index API INDEX of the API call information 330-2 may be represented by a value of “0” or “1.”

After operation 904, the automatic malignant code classification apparatus determines whether the whole API mapping bit array of the malignant behavior sequence is mapped to the index of the API call sequence (906). For example, the automatic malignant code classification apparatus determines whether the whole API mapping bit array 420 shown in FIG. 4 is mapped with a value of “1” corresponding to the index API INDEX of the API call information 330-2. When not the whole API mapping bit array of the malignant behavior sequence is mapped to the index of the API call sequence, operation 806 which will be described below is performed.

However, in operation 906, when the whole API mapping bit array is mapped to the index of the API call sequence, the automatic malignant code classification apparatus registers the behavior of the executed process corresponding to the malignant behavior sequence to be malignant behavior (908). For example, when the whole API mapping bit array 420 is mapped with the value of “1” corresponding to the index API INDEX of the API call information 330-2, the automatic malignant code classification apparatus may detect and register the behavior of the executed process corresponding to the malignant behavior sequence 410 or the malignant behavior sequence 330-1 to be malignant behavior.

After operation 802, the automatic malignant code classification apparatus classifies a malignant code related to the detected malignant behavior, using a malignant code classification metatable which stores pieces of information related to representative malignant behaviors which configure malignant codes (804).

As shown in FIG. 5, the malignant code classification metatable 500 may include the malignant code sequence 510, the malignant behavior information 520, and the malignant behavior sequence table 530. The malignant code sequence 510 may include k number of sequences corresponding to malignant code identification information. The malignant behavior sequence table 530 may include the malignant behavior sequence 530-1 and the malignant behavior index information 530-2 according to malignant code classification. The malignant behavior sequence 530-1 may include j number of sequences corresponding to malignant behavior identification information. The malignant behavior index information 530-2 may include index information for mapping with a behavior mapping table.

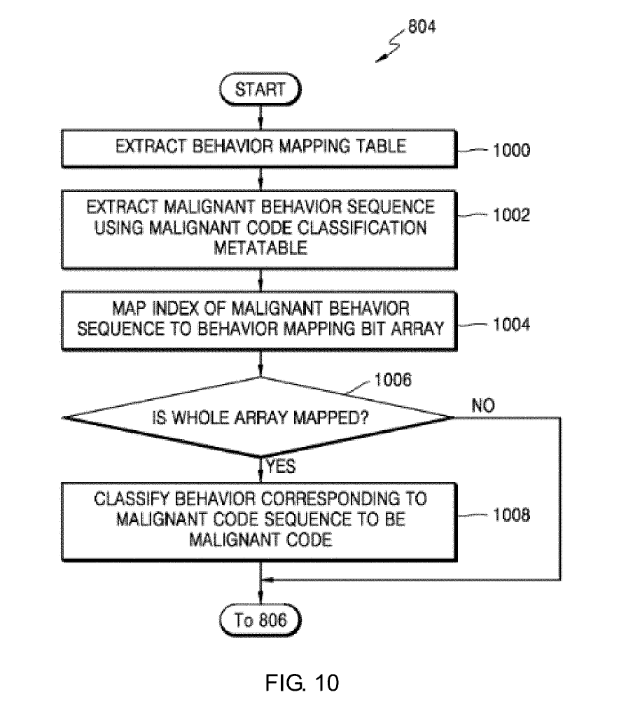

FIG. 10 is a flowchart illustrating one example of a process of classifying a malignant code related to the detected malignant behavior shown in FIG. 8.

The automatic malignant code classification apparatus extracts the behavior mapping table corresponding to the executed process from the process table (1000).

As shown in to FIG. 6, the behavior mapping table 600 may include the malignant code sequence 610 and the behavior mapping bit array 620. The malignant code sequence 610 may include k number of sequences corresponding to malignant code identification information and the number k is identical to the k number of malignant code sequences 510 retained in the malignant code classification metatable 500. The behavior mapping bit array 620 includes a bit array to be mapped with the index of the malignant behavior sequence 530-1 of the malignant code classification metatable 500 and may include the j number of behavior mapping bits, which is identical to the j number of malignant behavior sequences 530-1 retained in the malignant code classification metatable 500. For example, the automatic malignant code classification apparatus extracts the behavior mapping table 600 corresponding to the executed process (for example, xxx) from the process table 200. The extracted behavior mapping table 600 includes k number of malignant code sequences 610.

After operation 1000, the automatic malignant code classification apparatus extracts a malignant code sequence which includes the detected malignant behavior, using the malignant code classification metatable (1002). For example, the automatic malignant code classification apparatus may extract at least one malignant code sequence 510 including malignant behavior being currently detected, from the malignant code classification metatable 500 as shown in FIG. 5.

After operation 1002, the automatic malignant code classification apparatus maps an index of a malignant behavior sequence corresponding to the detected malignant behavior to the behavior mapping bit array of the malignant code sequence in the malignant behavior mapping table (1004). For example, the automatic malignant code classification apparatus may extract the index BEHAVIOR INDEX of the malignant behavior index information 530-2 corresponding to the malignant behavior sequence 530-1 with reference to the malignant behavior sequence table 530 of the malignant code classification metatable 500 as shown in FIG. 5. Afterward, the automatic malignant code classification apparatus maps the index BEHAVIOR INDEX of the malignant behavior index information 530-2 to the behavior mapping bit array 620 corresponding to the malignant code sequence 610 which includes malignant behavior in the behavior mapping table 600 as shown in FIG. 6. Here, the index BEHAVIOR INDEX of the malignant behavior index information 530-2 may be represented by a value of “0” or “1.”

After operation 1004, the automatic malignant code classification apparatus determines whether the whole behavior mapping bit array of the malignant code sequence is mapped to the index of the malignant behavior sequence (1006). For example, the automatic malignant code classification apparatus determines whether the whole behavior mapping bit array 620 shown in FIG. 6 is mapped with a value of “1” corresponding to the index BEHAVIOR INDEX of the malignant behavior index information 530-2. When not the whole behavior mapping bit array of the malignant code sequence is mapped to the index of the malignant behavior sequence, operation 806 which will be described below is performed.

However, in operation 1006, when the whole behavior mapping bit array is mapped to the index of the malignant behavior sequence, the automatic malignant code classification apparatus registers the behavior of the executed process corresponding to the malignant code sequence to be malignant code (1008). When the whole behavior mapping bit array 620 is mapped with the value of “1” corresponding to the index BEHAVIOR INDEX of the malignant behavior index information 530-2, the automatic malignant code classification apparatus may classify and register the behavior of the executed process corresponding to the malignant code sequence 610 or the malignant code sequence 530-1 to be a malignant code.

Meanwhile, after operation 804, the automatic malignant code classification apparatus determines whether an operation of the executed process is completed (806). As shown in FIG. 7, the automatic malignant code classification apparatus determines whether the operation of the executed process is completed, by comparing the process list 700 of the process table with the process list 710 being actually executed. When the operation of the executed process is not completed, the above-described process will be repeated from operation 800.

However, in operation 806, the operation of the executed process is completed; the automatic malignant code classification apparatus deletes the list of the executed process from the process table (808). The automatic malignant code classification apparatus may perform process termination by identifying a process which is not currently being executed among processes of the process table through looking up the processes to identify process termination caused by forced termination such as a crash and the like. For example, the automatic malignant code classification apparatus determines a process which does not exist in the process list 710 being actually executed in the process list 700 of the process table, to be terminated in execution thereof and deletes the process from the process table.

According to the embodiments of the present invention, malignant behavior is detected by managing life cycles of all processes executed by an end point and monitoring an API call executed after executing a process and a type of a malignant code corresponding to the detected malignant behavior is automatically executed by analyzing a pattern of the detected malignant behavior such that behavior of a malignant code with no signature may be detected. Also, malignant behavior information is analyzed and classified according to the type of the malignant code such that a response according to the type of the malignant code is available. Also, since behavior information in the life cycle of the process is analyzed, malignant behavior related to a malignant code which bypasses security equipment may be detected and classified using an analysis time.

While the exemplary embodiments of the present invention have been described above, it should be understood by one of ordinary skill in the art that modifications may be made without departing from the essential features of the present invention. Therefore, the disclosed embodiments should be considered not in a limitative point of view but in a descriptive point of view. It should be appreciated that the scope of the present invention is defined by the claims not by the above description and all differences within the equivalent scope thereof are included in the present invention.

What is claimed is:

1. A method of automatically classifying a malignant code on the basis of malignant behavior information, comprising:
configuring a process table comprising an application programming interface (API) mapping table and a behavior mapping table corresponding to each of processes according to a start of execution of the processes;
detecting malignant behavior of an executed process which is currently being executed, by using a malignant behavior metatable which stores malignant behavior information related to each of the processes; and
classifying a malignant code related to the detected malignant behavior by using a malignant code classification metatable which stores pieces of information on representative malignant behaviors which configure malignant codes.

2. The method of claim 1, wherein the detecting of the malignant behavior comprises:
extracting the API mapping table corresponding to the executed process from the process table;
extracting a malignant behavior sequence which comprises an API call of the executed process by using the malignant behavior metatable;
mapping an index of an API call sequence corresponding to the API call to an API mapping bit array of the malignant behavior sequence in the API mapping table;
determining whether the whole API mapping bit array of the malignant behavior sequence is mapped with the index of the API call sequence; and
registering, when the whole API mapping bit array is mapped with the index of the API call sequence, behavior of the executed process corresponding to the malignant behavior sequence to be malignant behavior.

3. The method of claim 1, wherein the malignant behavior metatable comprises a malignant behavior sequence, malignant behavior information, and an API call sequence table for detecting behaviors of previously analyzed malignant codes.

4. The method of claim 2, wherein the API mapping table and the malignant behavior metatable comprise the same malignant behavior sequence.

5. The method of claim 2, wherein the number of the API call sequences is identical to the number of bits of the API mapping bit array.

6. The method of claim 1, wherein the classifying of the malignant code comprises:
extracting a behavior mapping table corresponding to the executed process from the process table;
extracting a malignant code sequence which comprises the detected malignant behavior by using the malignant code classification metatable;
mapping an index of the malignant behavior sequence corresponding to the detected malignant behavior to a behavior mapping bit array of the malignant code sequence in the behavior mapping table;
determining whether the whole behavior mapping bit array of the malignant code sequence is mapped with the index of the malignant behavior sequence; and
registering, when the whole behavior mapping bit array is mapped with the index of the malignant behavior sequence, behavior of the executed process corresponding to the malignant code sequence to be the malignant code.

7. The method of claim 6, wherein the malignant code classification metatable comprises a malignant code sequence, malignant behavior information, and a malignant behavior sequence table for detecting representative behaviors of previously analyzed malignant codes.

8. The method of claim 6, wherein the behavior mapping table and the malignant code classification metatable comprise the same malignant code sequence.

9. The method of claim 6, wherein the number of the malignant behavior sequences is identical to the number of bits of the behavior mapping bit array.

10. The method of claim 1, further comprising:
determining whether an operation of the executed process is completed; and
deleting a list of the executed process from the process table when the operation of the executed process is completed.

11. The method of claim 10, wherein the determining of whether the operation of the executed process is completed comprises determining whether the operation of the executed process is completed by comparing a process list of the process table with a process list of processes which is being actually executed.

12. An apparatus for automatically classifying a malignant code on the basis of malignant behavior information, comprising:
a controller which configures a process table comprising an API mapping table and a behavior mapping table corresponding to each of processes according to a start of the processes;
a first processor which detects malignant behavior of an executed process which is currently being executed, by using a malignant behavior metatable which stores malignant behavior information related to each of the processes;
a second processor which classifies a malignant code related to the detected malignant behavior by using a malignant code classification metatable which stores pieces of information on representative malignant behaviors which configure malignant codes; and
a database which stores at least one of information related the API mapping table, information related the behavior mapping table, information related the process table, information related the malignant behavior metatable, and information related to the malignant code classification metatable.

13. The apparatus of claim 12, wherein the first processor extracts the API mapping table corresponding to the executed process from the process table, extracts a malignant behavior sequence which comprises an API call of the executed process by using the malignant behavior metatable, maps an index of an API call sequence corresponding to the API call to an API mapping bit array of the malignant behavior sequence in the API mapping table, determines whether the whole API mapping bit array of the malignant behavior sequence is mapped with the index of the API call sequence, and registers, when the whole API mapping bit array is mapped with the index of the API call sequence, behavior of the executed process corresponding to the malignant behavior sequence to be malignant behavior.

14. The apparatus of claim 12, wherein the second processor extracts a behavior mapping table corresponding to the executed process from the process table, extracts a malignant code sequence which comprises the detected malignant behavior by using the malignant code classification metatable, maps an index of the malignant behavior sequence corresponding to the detected malignant behavior to a behavior mapping bit array of the malignant code sequence in the behavior mapping table, determines whether the whole behavior mapping bit array of the malignant code sequence is mapped with the index of the malignant behavior sequence, and registers, when the whole behavior mapping bit array is mapped with the index of the malignant behavior sequence, behavior of the executed process corresponding to the malignant code sequence to be the malignant code.

15. The apparatus of claim 12, wherein the controller determines whether an operation of the executed process is completed and deletes a list of the executed process from the process table when the operation of the executed process is completed.

16. The apparatus of claim 12, wherein the controller determines an operation of the executed process is completed by comparing a process list of the process table with a process list of processes which is being actually executed.
